(19) United States
(12) Patent Application Publication
(10) Pub. No.: US 2026/0244919 A1
(43) Pub. Date: Aug. 20, 2026

(54) DATA PROCESSING METHOD, APPARATUS, AND DEVICE

(71) Applicant: Alipay (Hangzhou) Information Technology Co., Ltd., Hangzhou (CN)

(72) Inventor: Li WANG, Hangzhou (CN)

(21) Appl. No.: 19/159,307

(22) PCT Filed: Dec. 26, 2023
(86) PCT No.: PCT/CN2023/141759

§ 371 Date: Aug. 24, 2025

(30) Foreign Application Priority Data
Mar. 1, 2023 (CN) 202310215812.7

(51) Int. Cl. G06N 3/08

(52) U.S. Cl. CPC G06N 3/08

(57) ABSTRACT

Embodiments of this specification provide a data processing method, apparatus, and device. The method includes: when it is detected that there is a feature data missing in newly added feature data in first data, obtaining second data corresponding to the first data; inputting historical feature data in the first data into a pre-trained encoder model to obtain a first compression score corresponding to the historical feature data in the first data, and inputting historical feature data in the second data into the pre-trained encoder model to obtain a second compression score corresponding to the historical feature data in the second data; and determining target data corresponding to the first data in the second data based on the first compression score and the second compression score, and performing imputation processing on the newly added feature data in the first data based on newly added feature data in the target data.

### TECHNICAL FIELD

This specification relates to the field of data processing technologies, and in particular, to a data processing method, apparatus, and device.

### BACKGROUND

With rapid development of computer technologies, enterprises provide increasingly more types and an increasingly large quantity of application services to users. Accordingly, a data volume of user data is increasing, and a data structure is increasingly complex. There may be a data missing problem in to-be-detected data due to timeliness of data and other reasons.

For the data missing problem, imputation processing can be performed by using a default value. For example, for a feature item with a data missing, data imputation processing can be performed on the feature item by using the default value (for example, −1).

However, due to a relatively large quantity of feature items in the to-be-detected data and a relatively complex data structure, performing imputation processing on the data missing item by using the default value results in a poor imputation effect for missing data, affecting subsequent data processing accuracy. Therefore, there is a need for a solution that can improve the imputation effect for the missing data, to improve the subsequent data processing accuracy.

### SUMMARY

An objective of embodiments of this specification is to provide a data processing method, apparatus, and device, to provide a solution that can improve an imputation effect for missing data, to improve subsequent data processing accuracy.

To implement the above-mentioned technical solution, some embodiments of this specification are described as follows:

According to a first aspect, an embodiment of this specification provides a data processing method, including: when it is detected that there is a feature data missing in newly added feature data in first data, obtaining second data corresponding to the first data; inputting historical feature data in the first data into a pre-trained encoder model to obtain a first compression score corresponding to the historical feature data in the first data, and inputting historical feature data in the second data into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and determining target data corresponding to the first data in the second data based on the first compression score and the second compression score, and performing imputation processing on the newly added feature data in the first data based on newly added feature data in the target data, to obtain first data obtained after the imputation processing.

According to a second aspect, an embodiment of this specification provides a data processing apparatus. The apparatus includes: a first obtaining module, configured to: when it is detected that there is a feature data missing in newly added feature data in first data, obtain second data corresponding to the first data; a score obtaining module, configured to: input historical feature data in the first data into a pre-trained encoder model to obtain a first compression score corresponding to the historical feature data in the first data, and input historical feature data in the second data into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and a data imputation module, configured to: determine target data corresponding to the first data in the second data based on the first compression score and the second compression score, and perform imputation processing on the newly added feature data in the first data based on newly added feature data in the target data, to obtain first data obtained after the imputation processing.

According to a third aspect, an embodiment of this specification provides a data processing device. The data processing device includes: a processor; and a storage, configured to store computer-executable instructions. When the executable instructions are executed, the processor is enabled to perform the following operations: when it is detected that there is a feature data missing in newly added feature data in first data, obtaining second data corresponding to the first data; inputting historical feature data in the first data into a pre-trained encoder model to obtain a first compression score corresponding to the historical feature data in the first data, and inputting historical feature data in the second data into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and determining target data corresponding to the first data in the second data based on the first compression score and the second compression score, and performing imputation processing on the newly added feature data in the first data based on newly added feature data in the target data, to obtain first data obtained after the imputation processing.

According to a fourth aspect, an embodiment of this specification provides a storage medium. The storage medium is configured to store computer-executable instructions, and when the executable instructions are executed, the following procedure is implemented: when it is detected that there is a feature data missing in newly added feature data in first data, obtaining second data corresponding to the first data; inputting historical feature data in the first data into a pre-trained encoder model to obtain a first compression score corresponding to the historical feature data in the first data, and inputting historical feature data in the second data into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and determining target data corresponding to the first data in the second data based on the first compression score and the second compression score, and performing imputation processing on the newly added feature data in the first data based on newly added feature data in the target data, to obtain first data obtained after the imputation processing.

### BRIEF DESCRIPTION OF DRAWINGS

To describe the technical solutions in the embodiments of this specification or the related technology more clearly, the following briefly describes the accompanying drawings needed for describing the embodiments or the related technology. Clearly, the accompanying drawings in the following descriptions merely show some embodiments of this specification, and a person of ordinary skill in the art can still derive other drawings from these accompanying drawings without creative efforts.

FIG. 1A is a flowchart of an embodiment of a data processing method according to this specification;

FIG. 1B is a schematic diagram of a processing process of a data processing method according to this specification;

FIG. 2 is a schematic diagram of a processing process of another data processing method according to this specification;

FIG. 3 is a schematic diagram of an encoder model according to this specification;

FIG. 4 is a schematic diagram of a compression value obtaining process according to this specification;

FIG. 5 is a schematic diagram of an imputation processing process according to this specification;

FIG. 6 is a schematic diagram of a processing process of another data processing method according to this specification;

FIG. 7 is a schematic structural diagram of an embodiment of a data processing apparatus according to this specification; and

FIG. 8 is a schematic structural diagram of a data processing device according to this specification.

### DESCRIPTION OF EMBODIMENTS

Embodiments of this specification provide a data processing method, apparatus, and device.

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiment of this specification without creative efforts shall fall within the protection scope of this specification.

### Embodiment 1

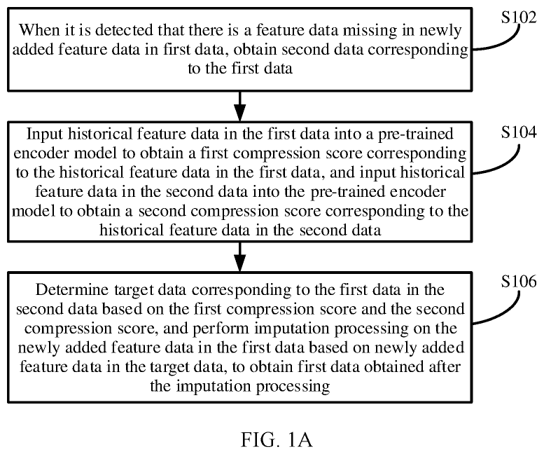

As shown in FIG. 1A and FIG. 1B, this embodiment of this specification provides a data processing method. The method can be performed by a server. The server can be an independent server, or can be a server cluster including a plurality of servers.

The method can specifically include the following steps S102 to S106.

S102: When it is detected that there is a feature data missing in newly added feature data in first data, obtain second data corresponding to the first data.

The first data can be data that corresponds to a preset service and/or a preset user and that is obtained in a preset obtaining period. The preset data obtaining period can be the past week, the past half-month, a preset time period each day, etc. Specifically, for example, the first data can be behavior data that is obtained from 10:00 to 14:00 each day and that is generated when the user triggers execution of a resource transfer service, or the first data can be a plurality of pieces of behavior data that is obtained in the past day and that is entered by the preset user in a man-machine interaction process, or the first data can be a plurality of pieces of behavior data that is obtained in the past week and that is entered when the preset user triggers execution of a resource transfer service. The first data can include one or more of text data, voice data, picture data, video data, and other data. The newly added feature data in the first data can be incremental data. That is, if the first data can include data obtained in the past three days, the newly added feature data in the first data can be data obtained in the past day, and the second data can be data determined based on a service or a user corresponding to the first data. For example, if the first data can be behavior data that is obtained from 10:00 to 14:00 each day and that is generated when a user A triggers execution of a resource transfer service, the second data can be behavior data that is obtained from 10:00 to 14:00 each day and that is generated when a user B triggers execution of the resource transfer service. Alternatively, if the first data can be a plurality of pieces of behavior data that is obtained in the past day and that is entered by the preset user in the man-machine interaction process, the second data can be a plurality of pieces of behavior data, etc. that is obtained in the past three days and that is entered by the preset user in the man-machine interaction process. Alternatively, if the first data can be behavior data that is obtained from 10:00 to 14:00 each day and that is generated when a user corresponding to a location A triggers execution of a resource transfer service, the second data can be behavior data, etc. that is obtained from 10:00 to 14:00 each day and that is generated when a user corresponding to a location B triggers execution of the resource transfer service.

In implementation, with rapid development of computer technologies, enterprises provide increasingly more types and an increasingly large quantity of application services to users. Accordingly, a data volume of user data is increasing, and a data structure is increasingly complex. There may be a data missing problem in to-be-detected data due to timeliness of data and other reasons. For the data missing problem, imputation processing can be performed by using a default value. For example, for a feature item with a data missing, data imputation processing can be performed on the feature item by using the default value (for example, −1). However, due to a relatively large quantity of feature items in the to-be-detected data and a relatively complex data structure, performing imputation processing on the data missing item by using the default value results in a poor imputation effect for missing data, affecting subsequent data processing accuracy. Therefore, there is a need for a solution that can improve the imputation effect for the missing data, to improve the subsequent data processing accuracy. In view of this, this embodiment of this specification provides a technical solution that can resolve the above-mentioned problem. For details, refer to the following content.

In implementation, because there may be different prevention and control requirements, associated time, associated space, associated background, etc. in different data detection periods, risks corresponding to data present different manifestations. For example, during a winter vacation and a summer vacation, the risk that a student group is deceived increases sharply. This requires that data samples used to train a detection model cover a relatively long time period, to ensure stable performance of the detection model. However, because new risk features are continuously generated, and data obtained by the server has a feature such as storage timeliness, there may be a data missing problem in feature data generated at a relatively early time. To improve training stability of the data detection model, imputation processing needs to be performed on feature missing data.

The server can perform data missing detection processing on obtained to-be-detected data, and can determine to-be-detected data with a feature data missing as the first data. For example, as shown in Table 1, the to-be-detected data can include resource transfer data generated by a user 1, a user 2, and a user 3 for the resource transfer service. To-be-detected data 1 can include to-be-detected data 1-1 and to-be-detected data 1-2, and to-be-detected data 2 can include to-be-detected data 2-1 and to-be-detected data 2-2. Based on a data obtaining time, it can be determined that the to-be-detected data 1-1 and the to-be-detected data 2-1 are newly added feature data.

TABLE 1

| Sequence | | | | | |
|---|---|---|---|---|---|
| number of | User | | Resource | Resource | Data |
| the to-be- | identi- | Device | transfer | transfer | obtaining |
| detected data | fier | identifier | time | quantity | time |
| To-be-detected | User 1 | Device 1 | Time 1 | — | Time 4 |
| data 1-1 | | | | | |
| To-be-detected | User 1 | Device 2 | Time 2 | Quantity 1 | Time 5 |
| data 1-2 | | | | | |
| To-be-detected | User 2 | — | Time 2 | Quantity 2 | Time 4 |
| data 2-1 | | | | | |
| To-be-detected | User 3 | Device 4 | Time 3 | Quantity 3 | Time 5 |
| data 2-2 | | | | | |

It can be learned from Table 1 that for the newly added to-be-detected data 1-1, there is a feature data missing in the resource transfer quantity corresponding to a case in which the user 1 triggers execution of the resource transfer service at the time 1 by using the device 1. Therefore, the server can determine the to-be-detected data 1 as the first data.

The server can obtain the second data corresponding to the first data. For example, the server can determine data with no feature data missing in the obtained to-be-detected data as the second data. For example, there is no feature data missing in the to-be-detected data 2-2 in Table 1. Therefore, the to-be-detected data 2 can be determined as the second data. Alternatively, if the first data is resource transfer data that is obtained by the server in the past three days, that corresponds to the location A, and that is generated when execution of the resource transfer service is triggered, the server can determine the resource transfer data that corresponds to the obtaining location B and that is generated when execution of the resource transfer service is triggered as the second data corresponding to the first data.

In addition, it can be learned from Table 1 that for the newly added to-be-detected data 2-1, there is a feature data missing in the device identifier corresponding to a case in which the user 2 triggers execution of the resource transfer service at the time 2. Therefore, the server can determine the to-be-detected data 2 as the first data. There is no feature data missing of the device identifier in the newly added to-be-detected data 1-1. Therefore, the server can determine the to-be-detected data 1 as the second data corresponding to the first data.

The above-mentioned methods for determining the first data and the corresponding second data are optional and implementable determining methods. In an actual application scenario, there can be a plurality of different determining methods, and different determining methods can be selected based on different actual application scenarios. This is not specifically limited in this embodiment of this specification.

S104: Input historical feature data in the first data into a pre-trained encoder model to obtain a first compression score corresponding to the historical feature data in the first data, and input historical feature data in the second data into the pre-trained encoder model to obtain a second compression score corresponding to the historical feature data in the second data.

The encoder model can be a model that is constructed based on a preset encoding algorithm and that is used to compress feature data into space of a preset dimension, and the preset dimension is less than a dimension of the feature data.

In implementation, the first data can include historical feature data and newly added feature data, and the second data can also include historical feature data and newly added feature data. For example, as shown in Table 1, if the first data can be the to-be-detected data 1, and the to-be-detected data 2 is the second data corresponding to the first data, based on the data obtaining time, it can be determined that the to-be-detected data 1-1 is newly added feature data in the first data, the to-be-detected data 1-2 can be historical feature data in the first data, the to-be-detected data 2-1 is newly added feature data in the second data, and the to-be-detected data 2-2 can be historical feature data in the second data.

The server can input the historical feature data in the first data into the pre-trained encoder model, and compress the historical feature data in the first data into the space of the preset dimension by using the encoder model, to obtain the first compression score corresponding to the first data. Similarly, the server can input the historical feature data in the second data into the pre-trained encoder model, and compress the historical feature data in the second data into the space of the preset dimension by using the encoder model, to obtain the second compression score corresponding to the second data.

For example, the preset dimension is one dimensional. The server can input the to-be-detected data 1-2 and the to-be-detected data 2-2 into the pre-trained encoder model, and separately perform compression processing on the two pieces of feature data by using the encoder model, to separately obtain a first compression score corresponding to the to-be-detected data 1 and a second compression score corresponding to the to-be-detected data 2. In this way, feature data of a plurality of dimensions can be mapped to the one-dimensional space, to improve subsequent data processing efficiency.

The preset dimension can be determined based on a detection efficiency requirement and/or a detection accuracy requirement of the first data. For example, if the detection efficiency requirement of the first data is relatively high and the detection accuracy requirement is relatively low, the server can determine that the preset dimension is a preset first dimension. Alternatively, if the detection efficiency requirement of the first data is relatively low and the detection accuracy requirement is relatively high, the server can determine a preset second dimension. The preset first dimension is less than the preset second dimension, and the preset second dimension is less than the dimension of the feature data input into the encoder model.

S106: Determine target data corresponding to the first data in the second data based on the first compression score and the second compression score, and perform imputation processing on the newly added feature data in the first data based on newly added feature data in the target data, to obtain first data obtained after the imputation processing.

In implementation, the server can determine second data corresponding to a second compression score, in second compression scores, whose difference from the first compression score is less than a preset difference threshold as the target data corresponding to the first data, and then perform imputation processing on missing feature data in the first data based on the target data, to obtain the first data obtained after the imputation processing.

For example, if there is a missing in data corresponding to a feature 1 in the newly added feature data in the first data, the server can perform imputation processing on the feature 1 in the newly added feature data in the first data based on data corresponding to the feature 1 in the target data, to obtain the first data obtained after the imputation processing. For example, the server can determine any one of a difference, a mean, a mode, etc. of the data corresponding to the feature 1 in the target data as the data corresponding to the feature 1 in the newly added feature data in the first data.

The first data obtained after the imputation processing can be used to perform subsequent data detection processing. For example, classification processing, risk detection processing, and similar data retrieval processing can be performed on the first data based on the first data obtained after the imputation processing.

According to the data processing method provided in this embodiment of this specification, when it is detected that there is a feature data missing in newly added feature data in first data, second data corresponding to the first data is obtained; historical feature data in the first data is input into a pre-trained encoder model to obtain a first compression score corresponding to the historical feature data in the first data, and historical feature data in the second data is input into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and target data corresponding to the first data in the second data is determined based on the first compression score and the second compression score, and imputation processing is performed on the newly added feature data in the first data based on newly added feature data in the target data, to obtain first data obtained after the imputation processing. In this way, the feature data can be compressed into the space of the preset dimension, to obtain the compression score, and the target data used to perform imputation processing on the first data is determined by using the compression score, thereby improving data processing efficiency. In addition, imputation processing is performed on the first data based on the target data. This avoids a problem of a poor imputation effect existing when imputation processing is performed in a manner such as by using a default value, that is, can improve an imputation effect for missing data and improve subsequent data processing accuracy.

### Embodiment 2

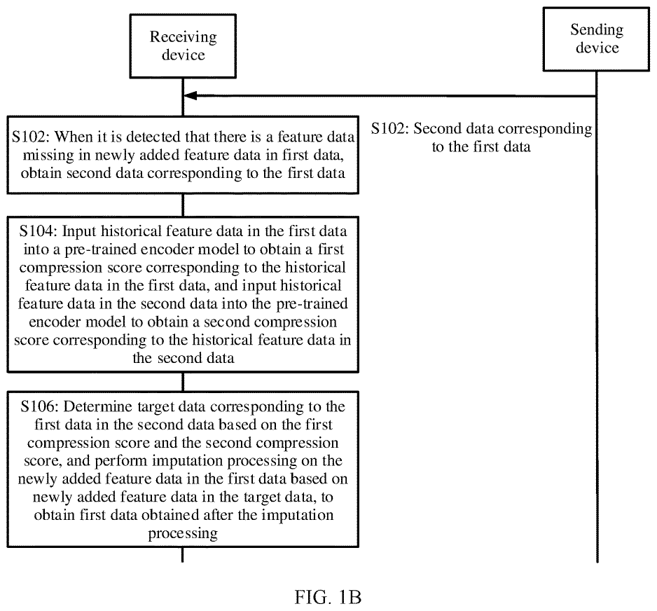

As shown in FIG. 2, this embodiment of this specification provides a data processing method. The method can be performed by a server. The server can be an independent server, or can be a server cluster including a plurality of servers. The method can specifically include the following steps S202 to S226.

S202: When it is detected that there is a feature data missing in newly added feature data in first data, obtain a target feature with a feature data missing in the newly added feature data in the first data, and obtain candidate data corresponding to the first data.

In implementation, the server can perform data missing detection processing on to-be-detected data, and can determine to-be-detected data with a feature data missing as the first data, and determine a feature with a feature data missing as the target feature. The candidate data can be data other than the first data in the to-be-detected data.

S204: Determine candidate data that is in the candidate data and in which there is no missing in feature data corresponding to the target feature as second data.

In implementation, if the candidate data includes to-be-detected data 2 and to-be-detected data 3, newly added feature data in the to-be-detected data 2 and the to-be-detected data 3 can be obtained, and data that is in the newly added feature data in the to-be-detected data 2 and the to-be-detected data 3 and in which there is no missing in feature data corresponding to the target feature can be determined as the second data. In this way, the candidate data can be screened by using the target feature, to ensure that the second data is data that can be used to perform imputation processing on the first data, thereby improving data processing efficiency.

S206: Obtain first sample data.

In implementation, if the first data is resource transfer data corresponding to a resource transfer service, the server can determine historical resource transfer data in the past month as the first sample data.

S208: Input the first sample data into an encoder module in an encoder model to obtain a third compression score corresponding to the first sample data.

S210: Input the third compression score into a decoder module in the encoder model to obtain second sample data corresponding to the third compression score.

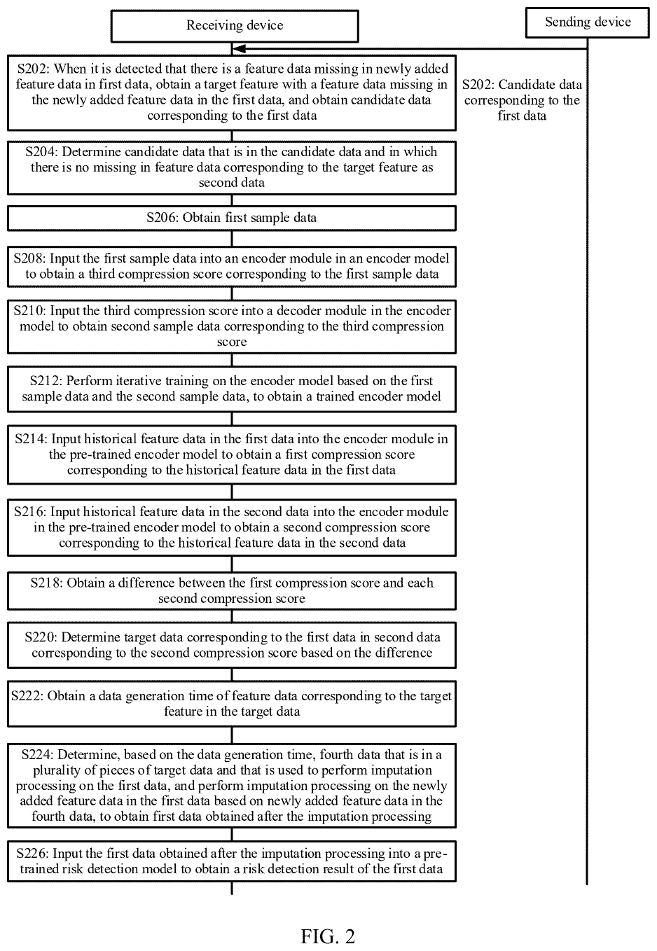

In implementation, for example, the encoder model includes an encoder module and a decoder module. As shown in FIG. 3, the first sample data can be input into the encoder module in the encoder model to obtain the third compression score corresponding to the first sample data, and then the third compression score is input into the decoder module in the encoder model to obtain the second sample data corresponding to the third compression score.

S212: Perform iterative training on the encoder model based on the first sample data and the second sample data, to obtain a trained encoder model.

In implementation, self-supervised training can be performed on the encoder model by using the first sample data and the second sample data, to obtain the trained encoder model.

In actual application, S212 can be processed in a plurality of manners. The following provides an optional implementation. For details, refer to processing in the following steps 1 to 4.

Step 1: Determine a risk loss function corresponding to the first data based on a risk detection requirement corresponding to the first data.

The risk loss function can be used to control a compression score output by the encoder model to meet the risk detection requirement.

In implementation, for different application scenarios, risk detection requirements for data are different. For example, for a resource transfer scenario, a risk detection requirement for a service execution time is relatively low, and a risk detection requirement for a service execution quantity is relatively high. For a page risk detection scenario, a risk detection requirement for a page refresh time is relatively high, and a risk detection requirement for a quantity of to-be-detected pages is relatively low. Therefore, the risk detection requirement corresponding to the first data can be obtained, and the risk loss function corresponding to the risk detection requirement can be determined, to control a compression direction of the encoder model for data by using the risk loss function, so that a compression score output by the encoder model meets the risk detection requirement.

For example, if the risk detection requirement corresponding to the first data is the risk detection requirement corresponding to the resource transfer scenario, the compression direction of the encoder model can be controlled by using the corresponding risk loss function. For example, the encoder model is controlled to increase a compression weight for the service execution time and decrease a compression weight for the service execution quantity. In this way, a weight of the service execution time is greater than a weight of the service execution quantity in the compression score output by the encoder model, to retain, as much as possible, feature data related to the risk detection requirement, increase a retention rate of effective information, improve subsequent risk detection accuracy, and improve robustness and stability of the encoder model.

Step 2: Input the first sample data into the encoder module in the encoder model to obtain a risk score corresponding to the first sample data.

Step 3: Determine a first loss value based on the first sample data and the second sample data, and determine a second loss value based on the risk score and the risk loss function.

Step 4: Perform iterative training on the encoder model based on the first loss value and the second loss value, to obtain the trained encoder model.

S214: Input historical feature data in the first data into the encoder module in the pre-trained encoder model to obtain a first compression score corresponding to the historical feature data in the first data.

S216: Input historical feature data in the second data into the encoder module in the pre-trained encoder model to obtain a second compression score corresponding to the historical feature data in the second data.

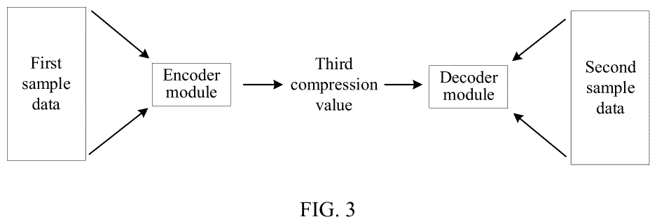

In implementation, as shown in FIG. 4, the encoder module in the trained encoder model can perform compression processing on the historical feature data in the first data to obtain the first compression score corresponding to the historical feature data in the first data, and perform compression processing on the historical feature data in the second data to obtain the second compression score corresponding to the historical feature data in the second data.

For example, a subsequent detection model (for example, a risk detection model) is a detection model constructed by using a neural algorithm. Variables in the to-be-detected data are mostly discrete statistical values, data that can be received by the model constructed by using the neural network algorithm is normalized continuous values within [−1, 1], and output data is also continuous values within [−1, 1]. Therefore, when entering a neural network for network propagation, the data needs to be normalized. For example, if a quantity of historical shopping times is 5, 0.1 is obtained after min-max normalization is performed on the data, and a predicted value obtained by the decoder module is 0.12. However, a value obtained after performing inverse transformation by using 0.12 may be 5.5. There is a difference between such a value distribution and cognitive experience. Therefore, to obtain imputation processing that is more in line with the cognitive experience and that can be used to better train the subsequent detection model, imputation processing can be performed on the first data without using the data obtained by the decoder module.

S218: Obtain a difference between the first compression score and each second compression score.

S220: Determine target data corresponding to the first data in second data corresponding to the second compression score based on the difference.

In implementation, target data corresponding to the first data in second data corresponding to a second compression score whose difference is less than a preset difference threshold can be determined, or second compression scores can be sorted based on the difference, and target data corresponding to the first data in second data corresponding to top n second compression scores in the sorted second compression scores can be determined. Herein, n can be determined based on a detection requirement of the first data.

S222: Obtain a data generation time of feature data corresponding to the target feature in the target data.

S224: Determine, based on the data generation time, fourth data that is in a plurality of pieces of target data and that is used to perform imputation processing on the first data, and perform imputation processing on the newly added feature data in the first data based on newly added feature data in the fourth data, to obtain first data obtained after the imputation processing.

In implementation, when there are a plurality of pieces of target data, the server can sort the target data based on the data generation time, and determine top m pieces of target data in the sorted target data as the fourth data. Herein, m can be determined based on a feature data imputation timeliness requirement of the first data. In this way, timeliness of the fourth data used to perform imputation on the first data can be ensured, to improve imputation processing accuracy.

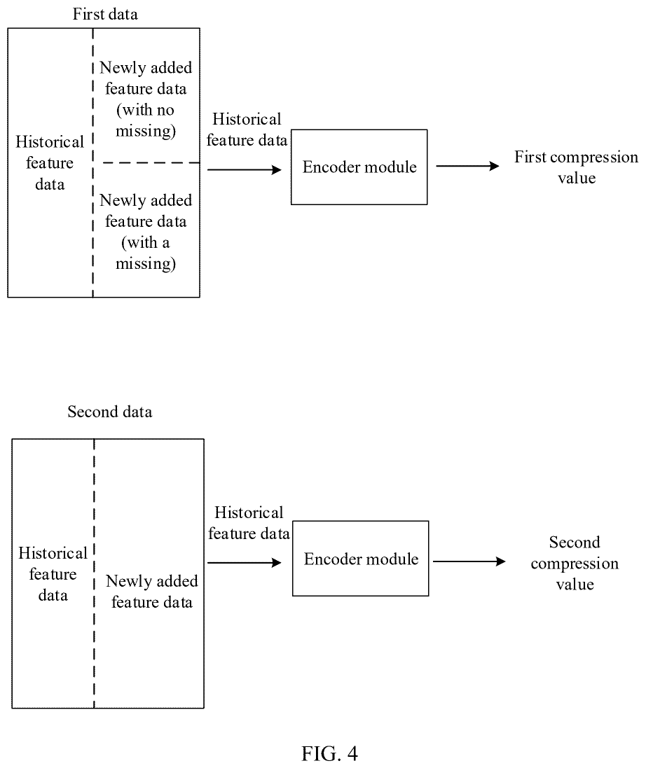

As shown in FIG. 5, feature data corresponding to the target feature in the newly added feature data in the fourth data can be copied to the first data, to perform imputation processing on the first data, so as to obtain the first data obtained after the imputation processing.

S226: Input the first data obtained after the imputation processing into a pre-trained risk detection model to obtain a risk detection result of the first data.

The risk detection model can be a model constructed based on a preset deep learning algorithm.

In implementation, for example, the risk detection model can be a model that is constructed by using a neural network algorithm and that is used to perform classification processing on data, that is, risk detection processing can be performed on the first data by using a classification result output by the risk detection model.

In this way, because imputation processing has been performed on the first data by using the target data, an accurate risk detection result can be obtained by using the first data obtained after the imputation processing, thereby improving accuracy of risk detection.

According to the data processing method provided in this embodiment of this specification, when it is detected that there is a feature data missing in newly added feature data in first data, second data corresponding to the first data is obtained; historical feature data in the first data is input into a pre-trained encoder model to obtain a first compression score corresponding to the historical feature data in the first data, and historical feature data in the second data is input into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and target data corresponding to the first data in the second data is determined based on the first compression score and the second compression score, and imputation processing is performed on the newly added feature data in the first data based on newly added feature data in the target data, to obtain first data obtained after the imputation processing. In this way, the feature data can be compressed into the space of the preset dimension, to obtain the compression score, and the target data used to perform imputation processing on the first data is determined by using the compression score, thereby improving data processing efficiency. In addition, imputation processing is performed on the first data based on the target data. This avoids a problem of a poor imputation effect existing when imputation processing is performed in a manner such as by using a default value, that is, can improve an imputation effect for missing data and improve subsequent data processing accuracy.

### Embodiment 3

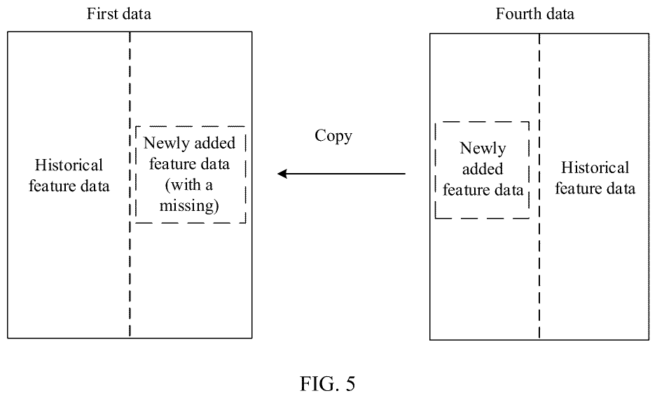

As shown in FIG. 6, this embodiment of this specification provides a data processing method. The method can be performed by a server. The server can be an independent server, or can be a server cluster including a plurality of servers. The method can specifically include the following steps S102 to S226.

S102: When it is detected that there is a feature data missing in newly added feature data in first data, obtain second data corresponding to the first data.

S206: Obtain first sample data.

S208: Input the first sample data into an encoder module in an encoder model to obtain a third compression score corresponding to the first sample data.

S210: Input the third compression score into a decoder module in the encoder model to obtain second sample data corresponding to the third compression score.

S212: Perform iterative training on the encoder model based on the first sample data and the second sample data, to obtain a trained encoder model.

S214: Input historical feature data in the first data into the encoder module in the pre-trained encoder model to obtain a first compression score corresponding to the historical feature data in the first data.

S216: Input historical feature data in the second data into the encoder module in the pre-trained encoder model to obtain a second compression score corresponding to the historical feature data in the second data.

302: Obtain a target feature with a feature data missing in the newly added feature data in the first data.

304: Determine second data that is in a plurality of pieces of second data and in which there is no missing in feature data corresponding to the target feature as third data.

In implementation, screening processing can be first performed on the second data based on the target feature, to improve subsequent data processing efficiency.

306: Obtain a difference between the first compression score and a second compression score corresponding to each piece of third data.

308: Determine target data corresponding to the first data in third data corresponding to the second compression score based on the difference.

For a specific processing process of S308, refer to related content of S204 in Embodiment 2. Details are omitted here for simplicity.

S222: Obtain a data generation time of feature data corresponding to the target feature in the target data.

S224: Determine, based on the data generation time, fourth data that is in a plurality of pieces of target data and that is used to perform imputation processing on the first data, and perform imputation processing on the newly added feature data in the first data based on newly added feature data in the fourth data, to obtain first data obtained after the imputation processing.

S226: Input the first data obtained after the imputation processing into a pre-trained risk detection model to obtain a risk detection result of the first data.

The risk detection model can be a model constructed based on a preset deep learning algorithm.

According to the data processing method provided in this embodiment of this specification, when it is detected that there is a feature data missing in newly added feature data in first data, second data corresponding to the first data is obtained; historical feature data in the first data is input into a pre-trained encoder model to obtain a first compression score corresponding to the historical feature data in the first data, and historical feature data in the second data is input into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and target data corresponding to the first data in the second data is determined based on the first compression score and the second compression score, and imputation processing is performed on the newly added feature data in the first data based on newly added feature data in the target data, to obtain first data obtained after the imputation processing. In this way, the feature data can be compressed into the space of the preset dimension, to obtain the compression score, and the target data used to perform imputation processing on the first data is determined by using the compression score, thereby improving data processing efficiency. In addition, imputation processing is performed on the first data based on the target data. This avoids a problem of a poor imputation effect existing when imputation processing is performed in a manner such as by using a default value, that is, can improve an imputation effect for missing data and improve subsequent data processing accuracy.

### Embodiment 4

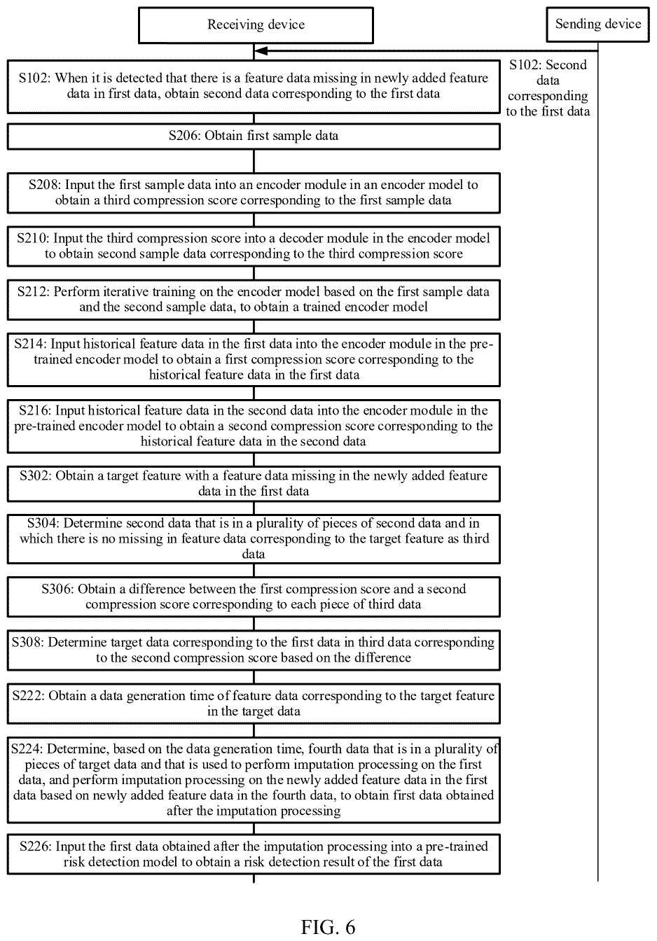

The data processing method provided in the embodiments of this specification is described above. Based on a same idea, this embodiment of this specification further provides a data processing apparatus, as shown in FIG. 7.

The data processing apparatus includes a first obtaining module 701, a score obtaining module 702, and a data imputation module 703. The first obtaining module 701 is configured to: when it is detected that there is a feature data missing in newly added feature data in first data, obtain second data corresponding to the first data. The score obtaining module 702 is configured to: input historical feature data in the first data into a pre-trained encoder model to obtain a first compression score corresponding to the historical feature data in the first data, and input historical feature data in the second data into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data. The data imputation module 703 is configured to: determine target data corresponding to the first data in the second data based on the first compression score and the second compression score, and perform imputation processing on the newly added feature data in the first data based on newly added feature data in the target data, to obtain first data obtained after the imputation processing.

In this embodiment of this specification, the apparatus further includes a risk detection module, configured to input the first data obtained after the imputation processing into a pre-trained risk detection model to obtain a risk detection result of the first data, where the risk detection model is a model constructed based on a preset deep learning algorithm.

In this embodiment of this specification, the apparatus further includes: a second obtaining module, configured to obtain first sample data; a first input module, configured to input the first sample data into an encoder module in the encoder model to obtain a third compression score corresponding to the first sample data; a second input module, configured to input the third compression score into a decoder module in the encoder model to obtain second sample data corresponding to the third compression score; and a model training module, configured to perform iterative training on the encoder model based on the first sample data and the second sample data, to obtain a trained encoder model; and the score obtaining module 702 is configured to input the historical feature data in the first data into the encoder module in the pre-trained encoder model to obtain the first compression score corresponding to the historical feature data in the first data.

In this embodiment of this specification, the model training module is configured to: determine a risk loss function corresponding to the first data based on a risk detection requirement corresponding to the first data, where the risk loss function is used to control a compression score output by the encoder model to meet the risk detection requirement; input the first sample data into the encoder module in the encoder model to obtain a risk score corresponding to the first sample data; determine a first loss value based on the first sample data and the second sample data, and determine a second loss value based on the risk score and the risk loss function; and perform iterative training on the encoder model based on the first loss value and the second loss value, to obtain the trained encoder model.

In this embodiment of this specification, the first obtaining module 701 is configured to: obtain a target feature with a feature data missing in the newly added feature data in the first data, and obtain candidate data corresponding to the first data; and determine candidate data that is in the candidate data and in which there is no missing in feature data corresponding to the target feature as the second data.

In this embodiment of this specification, the data imputation module 703 is configured to: obtain a difference between the first compression score and each second compression score; and determine target data corresponding to the first data in second data corresponding to the second compression score based on the difference.

In this embodiment of this specification, the data imputation module 703 is configured to: obtain a target feature with a feature data missing in the newly added feature data in the first data; determine second data that is in a plurality of pieces of second data and in which there is no missing in feature data corresponding to the target feature as third data; obtain a difference between the first compression score and a second compression score corresponding to each piece of third data; and determine target data corresponding to the first data in third data corresponding to the second compression score based on the difference.

In this embodiment of this specification, there are a plurality of pieces of target data, and the data imputation module 703 is configured to: obtain a data generation time of feature data corresponding to the target feature in the target data; and determine, based on the data generation time, fourth data that is in the plurality of pieces of target data and that is used to perform imputation processing on the first data, and perform imputation processing on the newly added feature data in the first data based on newly added feature data in the fourth data, to obtain the first data obtained after the imputation processing.

According to the data processing apparatus provided in this embodiment of this specification, when it is detected that there is a feature data missing in newly added feature data in first data, second data corresponding to the first data is obtained; historical feature data in the first data is input into a pre-trained encoder model to obtain a first compression score corresponding to the historical feature data in the first data, and historical feature data in the second data is input into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and target data corresponding to the first data in the second data is determined based on the first compression score and the second compression score, and imputation processing is performed on the newly added feature data in the first data based on newly added feature data in the target data, to obtain first data obtained after the imputation processing. In this way, the feature data can be compressed into the space of the preset dimension, to obtain the compression score, and the target data used to perform imputation processing on the first data is determined by using the compression score, thereby improving data processing efficiency. In addition, imputation processing is performed on the first data based on the target data. This avoids a problem of a poor imputation effect existing when imputation processing is performed in a manner such as by using a default value, that is, can improve an imputation effect for missing data and improve subsequent data processing accuracy.

### Embodiment 5

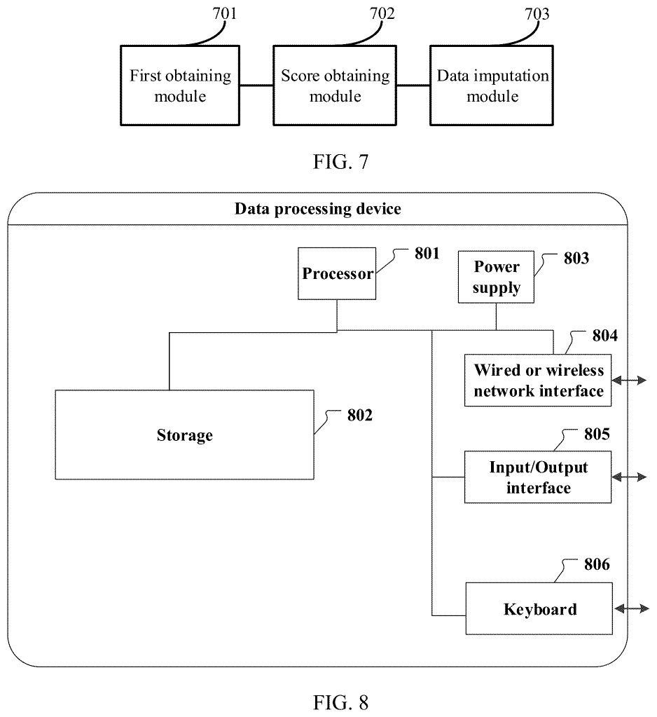

Based on a same idea, an embodiment of this specification further provides a data processing device, as shown in FIG. 8.

The data processing device can vary greatly based on configuration or performance, and can include one or more processors 801 and a storage 802. The storage 802 can store one or more storage applications or data. The storage 802 can be a transitory storage or persistent storage. The application stored in the storage 802 can include one or more modules (not shown in the figure), and each module can include a series of computer-executable instructions in the data processing device. Still further, the processor 801 can be configured to communicate with the storage 802, to execute a series of computer-executable instructions in the storage 802 on the data processing device. The data processing device can further include one or more power supplies 803, one or more wired or wireless network interfaces 804, one or more input/output interfaces 805, and one or more keyboards 806.

Specifically, in this embodiment, the data processing device includes a storage and one or more programs. The one or more programs are stored in the storage, the one or more programs can include one or more modules, and each module can include a series of computer-executable instructions in the data processing device. The one or more processors are configured to execute the computer-executable instructions included in the one or more programs to perform the following operations: when it is detected that there is a feature data missing in newly added feature data in first data, obtaining second data corresponding to the first data; inputting historical feature data in the first data into a pre-trained encoder model to obtain a first compression score corresponding to the historical feature data in the first data, and inputting historical feature data in the second data into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and determining target data corresponding to the first data in the second data based on the first compression score and the second compression score, and performing imputation processing on the newly added feature data in the first data based on newly added feature data in the target data, to obtain first data obtained after the imputation processing.

Optionally, the method further includes: inputting the first data obtained after the imputation processing into a pre-trained risk detection model to obtain a risk detection result of the first data, where the risk detection model is a model constructed based on a preset deep learning algorithm.

Optionally, before the inputting historical feature data in the first data into a pre-trained encoder model to obtain a first compression score corresponding to the historical feature data in the first data, the method further includes: obtaining first sample data; inputting the first sample data into an encoder module in the encoder model to obtain a third compression score corresponding to the first sample data; inputting the third compression score into a decoder module in the encoder model to obtain second sample data corresponding to the third compression score; and performing iterative training on the encoder model based on the first sample data and the second sample data, to obtain a trained encoder model; and the inputting historical feature data in the first data into a pre-trained encoder model to obtain a first compression score corresponding to the historical feature data in the first data includes: inputting the historical feature data in the first data into the encoder module in the pre-trained encoder model to obtain the first compression score corresponding to the historical feature data in the first data.

Optionally, the performing iterative training on the encoder model based on the first sample data and the second sample data, to obtain a trained encoder model includes: determining a risk loss function corresponding to the first data based on a risk detection requirement corresponding to the first data, where the risk loss function is used to control a compression score output by the encoder model to meet the risk detection requirement; inputting the first sample data into the encoder module in the encoder model to obtain a risk score corresponding to the first sample data; determining a first loss value based on the first sample data and the second sample data, and determining a second loss value based on the risk score and the risk loss function; and performing iterative training on the encoder model based on the first loss value and the second loss value, to obtain the trained encoder model.

Optionally, the obtaining second data corresponding to the first data includes: obtaining a target feature with a feature data missing in the newly added feature data in the first data, and obtaining candidate data corresponding to the first data; and determining candidate data that is in the candidate data and in which there is no missing in feature data corresponding to the target feature as the second data.

Optionally, the determining target data corresponding to the first data in the second data based on the first compression score and the second compression score includes: obtaining a difference between the first compression score and each second compression score; and determining target data corresponding to the first data in second data corresponding to the second compression score based on the difference.

Optionally, the determining target data corresponding to the first data in the second data based on the first compression score and the second compression score includes: obtaining a target feature with a feature data missing in the newly added feature data in the first data; determining second data that is in a plurality of pieces of second data and in which there is no missing in feature data corresponding to the target feature as third data; obtaining a difference between the first compression score and a second compression score corresponding to each piece of third data; and determining target data corresponding to the first data in third data corresponding to the second compression score based on the difference.

Optionally, there are a plurality of pieces of target data, and the performing imputation processing on the newly added feature data in the first data based on newly added feature data in the target data, to obtain first data obtained after the imputation processing includes: obtaining a data generation time of feature data corresponding to the target feature in the target data; and determining, based on the data generation time, fourth data that is in the plurality of pieces of target data and that is used to perform imputation processing on the first data, and performing imputation processing on the newly added feature data in the first data based on newly added feature data in the fourth data, to obtain the first data obtained after the imputation processing.

According to the data processing device provided in this embodiment of this specification, when it is detected that there is a feature data missing in newly added feature data in first data, second data corresponding to the first data is obtained; historical feature data in the first data is input into a pre-trained encoder model to obtain a first compression score corresponding to the historical feature data in the first data, and historical feature data in the second data is input into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and target data corresponding to the first data in the second data is determined based on the first compression score and the second compression score, and imputation processing is performed on the newly added feature data in the first data based on newly added feature data in the target data, to obtain first data obtained after the imputation processing. In this way, the feature data can be compressed into the space of the preset dimension, to obtain the compression score, and the target data used to perform imputation processing on the first data is determined by using the compression score, thereby improving data processing efficiency. In addition, imputation processing is performed on the first data based on the target data. This avoids a problem of a poor imputation effect existing when imputation processing is performed in a manner such as by using a default value, that is, can improve an imputation effect for missing data and improve subsequent data processing accuracy.

### Embodiment 6

This embodiment of this specification further provides a computer-readable storage medium. The computer-readable storage medium stores a computer program. When the computer program is executed by a processor, the processes in the above-mentioned data processing method embodiments are implemented, and same technical effects can be achieved. To avoid repetition, details are omitted here for simplicity. The computer-readable storage medium is, for example, a read-only memory (ROM), a random access memory (RAM), a magnetic disk, or an optical disc.

According to the computer-readable storage medium provided in this embodiment of this specification, when it is detected that there is a feature data missing in newly added feature data in first data, second data corresponding to the first data is obtained; historical feature data in the first data is input into a pre-trained encoder model to obtain a first compression score corresponding to the historical feature data in the first data, and historical feature data in the second data is input into the pre-trained encoder model to obtain a second compression score corresponding to the historical feature data in the second data, where the encoder model is a model that is constructed based on a preset encoding algorithm and that is used to compress feature data into space of a preset dimension, and the preset dimension is less than a dimension of the feature data; and target data corresponding to the first data in the second data is determined based on the first compression score and the second compression score, and imputation processing is performed on the newly added feature data in the first data based on newly added feature data in the target data, to obtain first data obtained after the imputation processing. In this way, the feature data can be compressed into the space of the preset dimension, to obtain the compression score, and the target data used to perform imputation processing on the first data is determined by using the compression score, thereby improving data processing efficiency. In addition, imputation processing is performed on the first data based on the target data. This avoids a problem of a poor imputation effect existing when imputation processing is performed in a manner such as by using a default value, that is, can improve an imputation effect for missing data and improve subsequent data processing accuracy.

Specific embodiments of this specification are described above. Other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multitasking and parallel processing are also feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented in any suitable manner. For example, the controller can be in a form such as a microprocessor, a processor, or a computer-readable medium, a logic gate, a switch, an application-specific integrated circuit (ASIC), a programmable logic controller, or an embedded microcontroller storing computer-readable program code (such as software or firmware) that can be executed by the (micro) processor. Examples of the controller include but are not limited to the following microcontrollers: ARC 625D, Atmel AT91SAM, Microchip PIC18F26K20, and Silicone Labs C8051F320. A storage controller can also be implemented as a part of control logic of a storage. A person skilled in the art also knows that in addition to implementing the controller by using only the computer-readable program code, logic programming can be performed on method steps to enable the controller to implement a same function in a form of a logic gate, a switch, an application-specific integrated circuit, a programmable logic controller, an embedded microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

The system, apparatus, module, or unit described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is separately described by dividing the apparatus into various units based on functions. Certainly, during implementation of one or more embodiments of this specification, the functions of each unit can be implemented in one or more pieces of software and/or hardware.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The embodiments of this specification are described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), an input/output interface, a network interface, and a memory.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in this specification, the computer-readable medium does not include transitory media such as a modulated data signal and carrier.

It should be further noted that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions executed by a computer, for example, a program module. Usually, the program module includes a routine, a program, an object, a component, a data structure, etc. for executing a specific task or implementing a specific abstract data type. Alternatively, the one or more embodiments of this specification can be practiced in distributed computing environments. In the distributed computing environments, tasks are executed by remote processing devices connected by using a communication network. In the distributed computing environments, the program module can be located in local and remote computer storage media including storage devices.

The embodiments of this specification are described in a progressive manner. For same or similar parts of the embodiments, refer to the embodiments. Each embodiment focuses on a difference from other embodiments. Particularly, the system embodiments are basically similar to the method embodiments, and therefore are described briefly. For related parts, refer to some descriptions in the method embodiments.

The above-mentioned descriptions are merely some embodiments of this specification and are not intended to limit this specification. A person skilled in the art can make various changes and variations to this specification. Any modifications, equivalent replacements, improvements, etc. made without departing from the spirit and principle of this specification shall fall within the scope of the claims of this specification.

1. A data processing method, comprising:
when it is detected that there is a feature data missing in newly added feature data in first data, obtaining second data corresponding to the first data;
inputting historical feature data in the first data into a pre-trained encoder model to obtain a first compression score corresponding to the historical feature data in the first data, and inputting historical feature data in the second data into the pre-trained encoder model to obtain a second compression score corresponding to the historical feature data in the second data, wherein the encoder model is a model that is constructed based on a preset encoding algorithm and that is used to compress feature data into space of a preset dimension, and the preset dimension is less than a dimension of the feature data; and
determining target data corresponding to the first data in the second data based on the first compression score and the second compression score, and performing imputation processing on the newly added feature data in the first data based on newly added feature data in the target data, to obtain first data obtained after the imputation processing.

2. The method according to claim 1, wherein the method further comprises:
inputting the first data obtained after the imputation processing into a pre-trained risk detection model to obtain a risk detection result of the first data, wherein the risk detection model is a model constructed based on a preset deep learning algorithm.

3. The method according to claim 1, wherein before the inputting historical feature data in the first data into a pre-trained encoder model to obtain a first compression score corresponding to the historical feature data in the first data, the method further comprises:
obtaining first sample data;
inputting the first sample data into an encoder module in the encoder model to obtain a third compression score corresponding to the first sample data;
inputting the third compression score into a decoder module in the encoder model to obtain second sample data corresponding to the third compression score; and
performing iterative training on the encoder model based on the first sample data and the second sample data, to obtain a trained encoder model; and
the inputting historical feature data in the first data into a pre-trained encoder model to obtain a first compression score corresponding to the historical feature data in the first data comprises:
inputting the historical feature data in the first data into the encoder module in the pre-trained encoder model to obtain the first compression score corresponding to the historical feature data in the first data.

4. The method according to claim 3, wherein the performing iterative training on the encoder model based on the first sample data and the second sample data, to obtain a trained encoder model comprises:
determining a risk loss function corresponding to the first data based on a risk detection requirement corresponding to the first data, wherein the risk loss function is used to control a compression score output by the encoder model to meet the risk detection requirement;
inputting the first sample data into the encoder module in the encoder model to obtain a risk score corresponding to the first sample data;
determining a first loss value based on the first sample data and the second sample data, and determining a second loss value based on the risk score and the risk loss function; and
performing iterative training on the encoder model based on the first loss value and the second loss value, to obtain the trained encoder model.

5. The method according to claim 1, wherein the obtaining second data corresponding to the first data comprises:
obtaining a target feature with a feature data missing in the newly added feature data in the first data, and obtaining candidate data corresponding to the first data; and
determining candidate data that is in the candidate data and in which there is no missing in feature data corresponding to the target feature as the second data.

6. The method according to claim 5, wherein the determining target data corresponding to the first data in the second data based on the first compression score and the second compression score comprises:
obtaining a difference between the first compression score and each second compression score; and
determining target data corresponding to the first data in second data corresponding to the second compression score based on the difference.

7. The method according to claim 1, wherein the determining target data corresponding to the first data in the second data based on the first compression score and the second compression score comprises:
obtaining a target feature with a feature data missing in the newly added feature data in the first data;
determining second data that is in a plurality of pieces of second data and in which there is no missing in feature data corresponding to the target feature as third data;
obtaining a difference between the first compression score and a second compression score corresponding to each piece of third data; and
determining target data corresponding to the first data in third data corresponding to the second compression score based on the difference.

8. The method according to claim 6, wherein there are a plurality of pieces of target data, and the performing imputation processing on the newly added feature data in the first data based on newly added feature data in the target data, to obtain first data obtained after the imputation processing comprises:
obtaining a data generation time of feature data corresponding to the target feature in the target data; and
determining, based on the data generation time, fourth data that is in the plurality of pieces of target data and that is used to perform imputation processing on the first data, and performing imputation processing on the newly added feature data in the first data based on newly added feature data in the fourth data, to obtain the first data obtained after the imputation processing.

9-11. (canceled)

12. A data processing device, wherein the data processing device comprises:
a processor; and
a storage, configured to store computer-executable instructions, wherein the executable instructions, when executed by the processor, cause the processor to:
when it is detected that there is a feature data missing in newly added feature data in first data, obtain second data corresponding to the first data;
input historical feature data in the first data into a pre-trained encoder model to obtain a first compression score corresponding to the historical feature data in the first data, and input historical feature data in the second data into the pre-trained encoder model to obtain a second compression score corresponding to the historical feature data in the second data, wherein the encoder model is a model that is constructed based on a preset encoding algorithm and that is used to compress feature data into space of a preset dimension, and the preset dimension is less than a dimension of the feature data; and
determine target data corresponding to the first data in the second data based on the first compression score and the second compression score, and perform imputation processing on the newly added feature data in the first data based on newly added feature data in the target data, to obtain first data obtained after the imputation processing.

13. The data processing device according to claim 12, wherein the processor is further caused to:
input the first data obtained after the imputation processing into a pre-trained risk detection model to obtain a risk detection result of the first data, wherein the risk detection model is a model constructed based on a preset deep learning algorithm.

14. The data processing device according to claim 12, wherein before the processor being caused to input historical feature data in the first data into a pre-trained encoder model to obtain a first compression score corresponding to the historical feature data in the first data, the processor is further caused to:
obtain first sample data;
input the first sample data into an encoder module in the encoder model to obtain a third compression score corresponding to the first sample data;
input the third compression score into a decoder module in the encoder model to obtain second sample data corresponding to the third compression score; and
perform iterative training on the encoder model based on the first sample data and the second sample data, to obtain a trained encoder model; and
the processor being caused to input historical feature data in the first data into a pre-trained encoder model to obtain a first compression score corresponding to the historical feature data in the first data comprises being caused to:
input the historical feature data in the first data into the encoder module in the pre-trained encoder model to obtain the first compression score corresponding to the historical feature data in the first data.

15. The data processing device according to claim 14, wherein the processor being caused to perform iterative training on the encoder model based on the first sample data and the second sample data, to obtain a trained encoder model comprises being caused to:
determine a risk loss function corresponding to the first data based on a risk detection requirement corresponding to the first data, wherein the risk loss function is used to control a compression score output by the encoder model to meet the risk detection requirement;
input the first sample data into the encoder module in the encoder model to obtain a risk score corresponding to the first sample data;
determine a first loss value based on the first sample data and the second sample data, and determine a second loss value based on the risk score and the risk loss function; and
perform iterative training on the encoder model based on the first loss value and the second loss value, to obtain the trained encoder model.

16. The data processing device according to claim 12, wherein the processor being caused to obtain second data corresponding to the first data comprises being caused to:
obtain a target feature with a feature data missing in the newly added feature data in the first data, and obtain candidate data corresponding to the first data; and
determine candidate data that is in the candidate data and in which there is no missing in feature data corresponding to the target feature as the second data.

17. The data processing device according to claim 16, wherein the processor being caused to determine target data corresponding to the first data in the second data based on the first compression score and the second compression score comprises being caused to:
obtain a difference between the first compression score and each second compression score; and
determine target data corresponding to the first data in second data corresponding to the second compression score based on the difference.

18. The data processing device according to claim 12, wherein the processor being caused to determine target data corresponding to the first data in the second data based on the first compression score and the second compression score comprises being caused to:
obtain a target feature with a feature data missing in the newly added feature data in the first data;
determine second data that is in a plurality of pieces of second data and in which there is no missing in feature data corresponding to the target feature as third data;
obtain a difference between the first compression score and a second compression score corresponding to each piece of third data; and
determine target data corresponding to the first data in third data corresponding to the second compression score based on the difference.

19. A non-transitory computer-readable storage medium storing instructions, wherein the non-transitory computer-readable storage medium stores a computer program, which when executed by a processor causes the processor to:
when it is detected that there is a feature data missing in newly added feature data in first data, obtain second data corresponding to the first data;
input historical feature data in the first data into a pre-trained encoder model to obtain a first compression score corresponding to the historical feature data in the first data, and input historical feature data in the second data into the pre-trained encoder model to obtain a second compression score corresponding to the historical feature data in the second data, wherein the encoder model is a model that is constructed based on a preset encoding algorithm and that is used to compress feature data into space of a preset dimension, and the preset dimension is less than a dimension of the feature data; and
determine target data corresponding to the first data in the second data based on the first compression score and the second compression score, and perform imputation processing on the newly added feature data in the first data based on newly added feature data in the target data, to obtain first data obtained after the imputation processing.

20. The non-transitory computer-readable storage medium according to claim 19, the processor is further caused to:
input the first data obtained after the imputation processing into a pre-trained risk detection model to obtain a risk detection result of the first data, wherein the risk detection model is a model constructed based on a preset deep learning algorithm.

21. The non-transitory computer-readable storage medium according to claim 19,
wherein before the processor being caused to input historical feature data in the first data into a pre-trained encoder model to obtain a first compression score corresponding to the historical feature data in the first data, the processor is further caused to:
obtain first sample data;
input the first sample data into an encoder module in the encoder model to obtain a third compression score corresponding to the first sample data;
input the third compression score into a decoder module in the encoder model to obtain second sample data corresponding to the third compression score; and
perform iterative training on the encoder model based on the first sample data and the second sample data, to obtain a trained encoder model; and
the processor being caused to input historical feature data in the first data into a pre-trained encoder model to obtain a first compression score corresponding to the historical feature data in the first data comprises being caused to:
input the historical feature data in the first data into the encoder module in the pre-trained encoder model to obtain the first compression score corresponding to the historical feature data in the first data.

22. The non-transitory computer-readable storage medium according to claim 21, wherein the processor being caused to perform iterative training on the encoder model based on the first sample data and the second sample data, to obtain a trained encoder model comprises being caused to:
determine a risk loss function corresponding to the first data based on a risk detection requirement corresponding to the first data, wherein the risk loss function is used to control a compression score output by the encoder model to meet the risk detection requirement;
input the first sample data into the encoder module in the encoder model to obtain a risk score corresponding to the first sample data;
determine a first loss value based on the first sample data and the second sample data, and determine a second loss value based on the risk score and the risk loss function; and
perform iterative training on the encoder model based on the first loss value and the second loss value, to obtain the trained encoder model.

23. The non-transitory computer-readable storage medium according to claim 19, wherein the processor being caused to obtain second data corresponding to the first data comprises being caused to:
obtain a target feature with a feature data missing in the newly added feature data in the first data, and obtain candidate data corresponding to the first data; and
determine candidate data that is in the candidate data and in which there is no missing in feature data corresponding to the target feature as the second data.
